(19) United States
(12) Patent Application Publication
(10) Pub. No.: US 2003/0143911 A1
(43) Pub. Date: Jul. 31, 2003

(54) Cleaning tool, method for making same

(76) Inventors: Vincent Boisseau, Cellule (FR); Christine Crux, Compiegne (FR); Jean Curtet, Bouffemont (FR); Bryan Johnson, Beauvais (FR); Nadine Poupa, Montargis (FR)

Correspondence Address: Clark & Brody, Suite 600, 1750 K Street N W, Washington, DC, 20006, US

(21) Appl. No.: 10/332,846

(22) PCT Filed: Jul. 16, 2001
(86) PCT No.: PCT/FR01/02299

(30) Foreign Application Priority Data
Jul. 17, 2000 (FR) 0009297

(51) Int. Cl. B32B 5/16; D04H 1/00; B05D 1/14; B05D 3/02; B32B 27/12; B32B 33/00

(52) U.S. Cl. 442/164; 428/90; 442/417; 442/394; 428/304.4; 427/385.5

(57) ABSTRACT

The present invention relates to a cleaning tool whose structure comprises a substrate to at least one side of which fibers have been fixed by flocking, said fibers covering at least part of said side and carrying droplets of binder mainly at their free end. Characteristically, said binder is filled in its bulk with abrasive particles and said fibers are present on at least part of said side at a density greater than 1000 fibers/cm². The present invention further relates to a process for the manufacture of said tool.

The present invention relates to a flocked cleaning tool suitable particularly for household maintenance. It further relates to the process for the manufacture of said tool.

The technique of flocking is a very old technique which consists in casting short textile fibers (generally with a length of between 0.1 and 20 mm), called flocks, onto a surface coated with the appropriate adhesive beforehand, to give the appearance of suede, felt, velvet or fur, according to the elements employed.

Said technique can be carried out in different variants. At the present time there are actually three main practical variants:

with striking or vibration of the substrate in question,

with pneumatic casting of the fibers, or

with electrostatic casting of the fibers,

which can also be combined in the so-called electro-striking variant or the so-called electro-pneumatic variant.

Said technique is perfectly described in the literature and has been mastered by those skilled in the art. Its field of application is very wide. It is employed in particular for producing materials used inter alia in the following industries: textiles, automobiles, building, packaging, paper and printing, luggage and case making, plastics, wood and furniture, footwear and toys.

Patent GB-B-1 539 477 recommended employing said flocking technique for the production of cleaning tools.

According to GB-B-1 539 477, said cleaning tools comprise a substrate on which short linear fibers are stuck by one of their ends, small volumes of acrylic resin being attached to the other, free end of said fibers. Said small volumes of acrylic resin are not necessarily discrete. Several of them may have coalesced, in which case a single volume of resin is fixed to several fibers.

Within the framework of one variant, abrasive particles are fixed to said small volumes of resin at the end of the fibers. Said abrasive particles are incorporated into the resin composition not upstream of its spraying onto the fibers, but downstream of the process, i.e. after said resin had been sprayed onto said fibers. The abrasive particles are sprinkled onto the fibers already carrying the volumes of resin (unpolymerized) at their free end. Thus said abrasive particles are not firmly anchored in the resin and, whatever the case may be, the abrasive capacity of the tool is strictly limited to the incorporation of said particles. Once said “surface” particles have worn away, there are no more to take over.

Finally, according to GB-B-1 539 477, significant gaps should be left between the fibers in order to ensure that, when the tool is used, it does not suffer from any problems of clogging or poor rinsability.

The objective of the inventors of the present invention was to develop a flocked cleaning tool—i.e. a tool of the type described in said patent GB-B-1 539 477 more than 20 years ago—which was optimized in terms of its abrasive character. To do this, they went against the teaching of said patent in terms of the density parameter of the flocks, and optimized the incorporation of the abrasive particles. Said particles are perfectly stabilized in the structure of the tool of the invention. They are incorporated further upstream in the process for the manufacture of said tool.

It is now proposed successively to describe the flocked cleaning tool of the invention and the process for its manufacture.

Said tool has a structure which comprises a substrate to at least one side of which fibers have been fixed by flocking, said fibers covering at least part of said side and carrying droplets of binder mainly at their free end (end not fixed to said substrate). As such, said tool is a cleaning tool in the sense of patent GB-B-1 539 477.

Characteristically, in the structure of said tool of the invention:

the binder is filled in its bulk with abrasive particles; and

the fibers (or flocks) are present on at least part of said side at a density greater than 1000 fibers/cm².

According to the invention, the abrasive particles are present in the bulk of the binder and more precisely in the bulk of the droplets of said binder. They are firmly anchored thereto, the majority being totally embedded and hence perfectly stabilized.

In addition to the totally embedded particles, there are advantageously emergent particles. Their degree of anchorage generally remains reasonable insofar as they are incorporated with the binder (cf. description of the process below). The presence of excessively emergent particles that are unstable and liable to be stripped off cannot be totally excluded. Advantageously, the cleaning tool of the invention contains no (or very few) such abrasive particles that are excessively emergent.

Whatever the case may be, when the flocked cleaning tool according to the invention is used, said excessively emergent abrasive particles, said emergent particles and, finally, said immersed particles (of the new tool) are successively consumed (by stripping or wear).

The droplets of binder are advantageously filled in their bulk with the abrasive particles under conditions which are optimized in terms of the abrasive character of the flocked tool. Within said droplets, said binder is thus advantageously filled in a ratio (λ), defined as follows:

$$λ = \frac{Particle Volume Concentration}{Critical Particle Volume Concentration} = \frac{PVC}{CPVC} ,$$

greater than 0.5, preferably greater than 0.9.

These concepts of Particle Volume Concentration (PVC) and Critical Particle Volume Concentration (CPVC) are familiar to those skilled in the art.

For information, it is pointed out here that the Particle Volume Concentration (PVC) of a filler is defined by the following relationship:

$$PVC ( \% ) = 100 \cdot \frac{Vf}{Vf + Vb} ,$$

where Vf represents the volume of fillers (in this case abrasive particles) and Vb represents the volume of binder. These volumes are calculated from the weights and densities of the components of the formulation in question, i.e. the binder and the abrasive particles in this case. It is also pointed out that the Critical Particle Volume Concentration (CPVC) of a filler is determined by measuring the oil uptake of said filler according to standard ISO 787-5.

Thus, within the framework of the present invention, it is advantageous, both from the point of view of optimization of the abrasive character and from the economic point of view, for the parameter λ defined above to be greater than 0.5, preferably greater than 0.9 and in fact as close as possible to 1. It is noted incidentally here that a value greater than 1 is not excluded, but that the presence of excessively emergent particles is not really desirable.

Within the framework of the present invention, it is therefore advantageous to incorporate the binder in the minimum amount (but nevertheless sufficient amount) necessary to fill the gaps between the abrasive particles.

This optimization of the respective amounts of fillers and binder within the abrasive droplets is optimization in terms of the abrasive character of the final flocked product.

According to the invention, attempts were also made to optimize the distribution of the abrasive formulation—the precursor of the filled droplets—for the purpose of obtaining a product with one droplet per fiber and with a minimum coalescence of said droplets. By minimizing the coalescence in this way, savings are made in terms of the amount of filled binder required, the abrasiveness of the final flocked product is optimized and its rinsability is increased (by minimizing clogging).

In the spirit of this optimization, the flocked cleaning tool of the invention therefore carries, at the free end of its fibers (flocks), droplets of filled binder whose mean equivalent diameter (Øₘ) is such that: Øₘ<f+4c, f representing the mean equivalent diameter of said fibers and c that of the abrasive particles present in said droplets.

Even more advantageously, said mean equivalent diameter of said droplets (Øₘ) is in the order of or equal to f+2c (f representing the mean equivalent diameter of the fibers in question and c that of the abrasive particles in question).

The flocked side(s) of the substrates of the cleaning tools according to the invention therefore has (have) flocks, at a density greater than 1000 flocks/cm², which carry, at their free end, droplets of binder filled in their bulk with abrasive particles. Said droplets are advantageously characterized by:

a ratio λ>0.5, very advantageously>0.9;

a mean equivalent diameter Øₘ<f+4c, very advantageously in the order of or equal to f+2c.

The flocking density can be further defined as follows.

It is greater than 1000 fibers/cm². It is advantageously less than 4000 fibers/cm² and very advantageously less than 3500 fibers/cm².

Preferably, it is between 2000 and 2500 fibers/cm².

Totally surprisingly, high-performance tools were obtained according to the invention with such flocking densities. Coalescence of the droplets was successfully limited or even totally avoided.

Very high-performance tools were obtained according to the invention by combining such flocking densities with optimized characteristics for the droplets of filled binder (λ, Øₘ).

It is pointed out incidentally here that the fibers fixed by flocking to the substrate of the tools of the invention carry the droplets of filled binder mainly at their free end, although the presence of such droplets along said fibers cannot be totally excluded.

The tools of the invention can exist in different forms, especially:

with one or more of their sides flocked;

with the side(s) uniformly or non-uniformly flocked over all or part of its (their) surface.

In a first variant, the cleaning tool of the invention is uniformly flocked over the whole of one of its main sides.

In a second variant, the cleaning tool of the invention is non-uniformly flocked over at least part of one of its sides. Thus the flocked fibers used can have different lengths, advantageously two different lengths, the distribution of the fibers of different length being random or ordered.

It is possible to have fibers of different length over at least two zones of one side, the length of said fibers being substantially the same in each of said zones. It is thus possible to generate a strongly scouring zone (zone of short fibers) and a weakly scouring zone (zone of long, more supple fibers).

A further possibility is to have a mixture of short fibers and long fibers over at least part of one side. In such a case, different colorations, advantageously assigned respectively to the long fibers with resin and to the short fibers, allow the degree of wear of the material to be assessed, the coloration changing from that of the long fibers with resin to that of the short fibers. Other scenarios are completely possible.

A flocked tool can just as well be produced dissymmetrically on both of its two main sides.

It is now proposed to give a few non-limiting details about the nature of each of the main constituents—the substrate, the fibers, the binder and the abrasive particles—of the tools of the invention.

Said substrate, which is generally supple and flexible, advantageously consists of a nonwoven, a synthetic or artificial sponge or a nonwoven fixed to such as sponge. It very advantageously consists of such a nonwoven fixed to a sponge. The nonwoven can be fixed to the sponge in any way, especially by lamination, needle bonding or sewing.

In particular, the fibers can be polyamide, polyester, polypropylene or acrylic fibers. They advantageously consist of polyamide. With reference to the flocking to be carried out, said fibers are not excessively long (cf. introduction). It has been seen elsewhere that the abrasive character of the assembly decreases with the length of said fibers. The fibers used preferably have a length of between 2 and 5 mm.

The binder used is advantageously based on a thermosetting resin, especially a thermosetting phenolic, acrylic, epoxy or melamine resin. It is very advantageously based on a thermosetting phenolic resin. The use of other types of resins, especially resins curable under ultraviolet or other types of radiation, is in no way excluded. It has already been seen that the binder is sprayed upstream in a filled, uncured state and that the substrate carrying the droplets of said filled, uncured binder is then treated, generally heat-treated, in order to cure said droplets of said filled binder.

The abrasive particles or fillers are advantageously selected from mineral particles of silica, alumina, calcite, silicon carbide, talcum and mixtures thereof. They advantageously consist of silica and/or alumina. If a weaker cleaning power is sought, it is not excluded to use synthetic (organic) fillers such as particles of polyethylene terephthalate (PET), polymethyl methacrylate (PMMA), polyurethane (PU), polystyrene (PS), etc.

In the present text, all these mineral and organic fillers have been referred to as abrasive fillers.

Whatever the case may be, according to the invention the amount of material (binder+abrasive particles) used is minimized principally by making provision for droplets of filled binder only at the free end of the fibers, and the efficacy of said droplets is optimized in a context of short, “rigid” fibers with a high implantation density.

In one particularly preferred variant, the cleaning tool of the invention consists of or comprises a nonwoven with polyamide flocks, there being droplets of a crosslinked phenolic resin, filled with silica and/or alumina particles, mainly at the free end of said flocks. Said flocks are advantageously perfectly individualized. Obviously, the coalescence of some of the droplets—a small percentage at any event—cannot be totally excluded.

We now turn to the process for the manufacture of the cleaning tools according to the invention, namely optimized flocked tools.

Said process characteristically comprises:

the preparation of a curable (generally thermosetting) binder filled with abrasive particles (said particles being incorporated well upstream in said process);

the flocking, with fibers, of at least part of at least one of the sides of said substrate (it has been seen that all or part of one or more sides can be involved, in a uniform or non-uniform manner), said part having been rendered adhesive beforehand (in a manner known per se) and said flocking being carried out so as to give a fiber density greater than 1000 fibers/cm² (it has been seen that said density can be optimized);

the application (generally by spraying) of said filled curable binder to the resulting flocked substrate in such a way as to position droplets of said filled binder mainly at the free end of said fibers; and

the treatment, generally heat treatment, of said flocked substrate carrying filled curable binder, the purpose of the treatment being to cure said binder (i.e. to stabilize the droplets, filled in their bulk, at the end of the “linear” fibers).

Flocking is a process known per se. Reference may be made in this connection to the introduction of the present text. Characteristically, it is carried out according to the invention in order to create cleaning tools with a relatively high fiber density, and is coupled with the application, to the free end of said fibers, of droplets of binder filled with abrasive particles.

Within the framework of the implementation of the process of the invention, the flocking is advantageously electrostatic flocking carried out continuously on a moving strip of the substrate.

As regards the preparation of a tool of the invention which has fibers of different length on one and the same side, the flocking operation can be carried out in several variants. To distribute said fibers of different length in different zones, either at least two successive independent flocking operations are carried out (one with short fibers and the other with long fibers in the case where two kinds of fibers are used, namely short and long), or a single flocking operation is carried out with long fibers and some of said long fibers are cut over the appropriate area to convert them to shorter fibers.

If said fibers of different length are used in a mixture, a single flocking of said mixture is carried out.

It is now proposed to illustrate the invention by means of the Examples below.

The starting materials used to manufacture cleaning tools according to the invention are described in detail below.

The substrate is a nonwoven weighing about 60 g/m² and composed of viscose and polyester fibers bound by needle bonding and the application of latex resin.

The flock fibers are polyamide 6,6 fibers with a length of 4 mm and a fiber fineness of 22 dtex, conditioned for flocking. They have a mean equivalent diameter f of 50 μm.

The abrasive formulation used (precursor of the filled droplets of binder) consist of the following per 100 g:

23.4 g of a resol-type phenolic resin marketed by CRAY VALLEY under the trade name Norsophen,

20.7 g of distilled water,

0.3 g of green pigment marketed by FAPCO under the name Vert 60202, and

55.6 g of abrasive fillers consisting of silica marketed by SIFRACO under the mark C4. The silica grains have a mean equivalent diameter c of 55 μm. For this silica (density 2.65) the oil uptake according to standard ISO 787-5 is 19 ml of linseed oil (density 0.935) per 100 g of filler. The CPVC is therefore equal to 64.99%:

$$( CPVC = 100 \cdot \frac{100 / 2.65}{100 / 2.65 + 19 / 0.935} = 64.99 \% ) .$$

It is obtained by simply mixing its constituents.

It is characterized by the following parameter:

$$λ = \frac{PVC}{CPVC} = 0.94 ( calculated on the basis of dry resin ) .$$

### EXAMPLE 1

a) The substrate (a nonwoven), stored on rollers, is unwound. One of its sides is blade-coated on a cylinder with 200 g/m² by wet weight of an adhesive composed of 90% by weight of acrylic glue and 10% by weight of hardener.

The nonwoven coated with adhesive then passes through an AIGLE-type flocking booth. The flock fibers falling on the adhesive layer are orientated vertically by an electric field of up to 100 kV. A nonwoven beating system ensures that the fibers are well embedded in the adhesive and the excess fibers are removed by suction.

The adhesive used is dried and crosslinked by passage of the flocked nonwoven through a hot-air tunnel oven at 180° C. for 5 minutes.

The flocked nonwoven is then cooled on a cylinder, brushed to remove the incorrectly embedded fibers, and then wound up.

The flocking operation was carried out to give a fiber density of 2500 fibers per cm².

b) The flocked nonwoven is unwound continuously with its flocked side facing upwards. The abrasive formulation is sprayed uniformly over the whole of said flocked side by means of compressed-air nozzles.

The spraying is followed by a heat treatment in a hot-air tunnel oven at 180° C. for 5 minutes to dry and crosslink the abrasive formulation.

The abrasive deposit represents 150 g/m² by dry weight. The droplets generated at the free end of the fibers have a mean equivalent diameter 2.2 c+f of ≈171 μm. This value results from a theoretical calculation and was verified by microscopy. There is generally one filled droplet per fiber.

c) The cleaning tool obtained was tested.

Its abrasiveness was measured in conventional manner on a Taber-type abrasion tester.

A moist sample of said tool, with a diameter of 125 mm, was rotated at 60 rpm. Two aluminum wheels, with a diameter of 50 mm and a thickness of 12 mm, were then rubbed against the flocked side of said sample. A weight of 1.5 kg is applied to each of said wheels.

The loss in weight of said wheels is evaluated by the difference in their weight before and after rubbing for 50 revolutions and then 200 revolutions.

The characteristics of the tool of the invention, and the results of the Taber test, are indicated in the Table below:

| $\begin{matrix}Density \\ ( fibers / {cm}^{2} )\end{matrix}$ | $λ = \frac{PVC}{CPVC}$ | $\begin{matrix}Mean equivalent \\ diameter of the filled \\ droplets of binder \\ {Ø}_{m} \approx 2.2 c + f \\ ( μm )\end{matrix}$ | $\begin{matrix}Proportion of \\ abrasive \\ ( g / {m}^{2} )\end{matrix}$ | $\begin{matrix}Loss in \\ weight after \\ 50 revolutions \\ ( mg )\end{matrix}$ | $\begin{matrix}Loss in \\ weight after \\ 200 revolutions \\ ( mg )\end{matrix}$ |
|---|---|---|---|---|---|
| 2500 | 0.94 | 171 | 150 | 24.5 | 88.4 |

### EXAMPLE 2

Samples of cleaning tools according to the invention are produced with the starting materials indicated above using the process described in detail in Example 1.

The density of the fibers is varied from sample to sample. The spraying rate of the abrasive formulation is adapted to each fiber density so as to deposit about one droplet per fiber, each droplet having a mean equivalent diameter corresponding to 2 c+f≈160 μm.

The samples are tested on the Taber abrasion tester. The characteristics of said samples, and the test results, are indicated in the Table below:

| $\begin{matrix}Density \\ ( fibers / {cm}^{2} )\end{matrix}$ | $λ = \frac{PVC}{CPVC}$ | $\begin{matrix}Mean equivalent \\ diameter of the filled \\ droplets of binder \\ {Ø}_{m} \approx 2.2 c + f \\ ( μm )\end{matrix}$ | $\begin{matrix}Proportion of \\ abrasive \\ ( g / {m}^{2} )\end{matrix}$ | $\begin{matrix}Loss in \\ weight after \\ 50 revolutions \\ ( mg )\end{matrix}$ | $\begin{matrix}Loss in \\ weight after \\ 200 revolutions \\ ( mg )\end{matrix}$ |
|---|---|---|---|---|---|
| 1386 | 0.94 | 160 | 62 | 19 | 43.8 |
| 1897 | 0.94 | 160 | 88 | 25.7 | 71.6 |
| 2772 | 0.94 | 160 | 142 | 29.7 | 89.6 |
| 4170 | 0.94 | 160 | 199 | 18.2 | 68.8 |

These results show that the abrasiveness increases with the number of fibers and reaches an optimum at about 2500-3000 fibers/cm². Beyond that, the drop in performance characteristics is due to the difficulty of keeping the droplets discrete in the spraying process. In fact, the droplets are close together because of the high fiber density and therefore tend to coalesce.

1. A cleaning tool whose structure comprises a substrate to at least one side of which fibers have been fixed by flocking, said fibers covering at least part of said side and carrying droplets of binder mainly at their free end, characterized in that said binder is filled in its bulk with abrasive particles and in that said fibers are present on at least part of said side at a density greater than 1000 fibers/cm².

2. The cleaning tool according to claim 1, characterized in that said binder is filled with said abrasive particles such that the ratio
$$λ = \frac{Particle Volume Concentration}{Critical Particle Volume Concentration}$$
is greater than 0.5, advantageously greater than 0.9.

3. The cleaning tool according to claim 1 or 2, characterized in that the mean equivalent diameter (Øₘ) of said droplets of filled binder is such that
Øₘ<f+4c,
f representing the mean equivalent diameter of the fibers at the ends of which said droplets are present, and c representing the mean equivalent diameter of the abrasive particles present in said droplets.

4. The cleaning tool according to claim 3, characterized in that said mean equivalent diameter (Øₘ) of said droplets of filled binder is in the order of or equal to f+2c.

5. The cleaning tool according to any one of claims 1 to 4, characterized in that said fibers are present on at least part of said side at a density of less than 4000 fibers/cm², advantageously of less than 3500 fibers/cm².

6. The cleaning tool according to any one of claims 1 to 5, characterized in that said fibers are present on at least part of said side at a density of between 2000 and 2500 fibers/cm².

7. The cleaning tool according to any one of claims 1 to 6, characterized in that said fibers are present on said side in different lengths, advantageously in two different lengths.

8. The cleaning tool according to claim 7, characterized in that said fibers are present in at least two zones of said side in different lengths, the length of said fibers being substantially the same in each of said zones.

9. The cleaning tool according to any one of claims 1 to 8, characterized in that said substrate consists of a nonwoven, a synthetic or artificial sponge or a nonwoven fixed to such a sponge.

10. The cleaning tool according to any one of claims 1 to 9, characterized in that said fibers are polyamide, polyester or polypropylene fibers, advantageously polyamide fibers.

11. The cleaning tool according to any one of claims 1 to 10, characterized in that said binder is based on a thermosetting phenolic, acrylic, epoxy or melamine resin, advantageously a thermosetting phenolic resin.

12. The cleaning tool according to any one of claims 1 to 11, characterized in that said abrasive particles are selected from particles of silica, alumina, calcite, silicon carbide, talcum and mixtures thereof.

13. A process for the manufacture of a cleaning tool according to any one of claims 1 to 12, characterized in that said process comprises:
the preparation of a curable binder filled with abrasive particles;
the flocking of at least part of at least one of the sides of a substrate with fibers, said part having been rendered adhesive beforehand and said flocking being carried out so as to give a fiber density greater than 1000 fibers/cm²;
the application of said filled curable binder to the resulting flocked substrate in such a way as to position droplets of said filled binder mainly at the free end of said fibers; and
the treatment, generally heat treatment, of said flocked substrate carrying filled curable binder, the purpose of the treatment being to cure said binder.

14. The process according to claim 13, characterized in that said flocking is electrostatic flocking carried out continuously on a moving strip of said substrate.
